(19) United States
(12) Patent Application Publication
(10) Pub. No.: US 2016/0098287 A1
(43) Pub. Date: Apr. 7, 2016

(54) Method and System for Intelligent Analytics on Virtual Deployment on a Virtual Data Centre

(71) Applicants: Dhanyamraju S U M Prasad, Hyderabad (IN); Hareendran M, Chennai (IN)

(72) Inventors: Dhanyamraju S U M Prasad, Hyderabad (IN); Hareendran M, Chennai (IN)

(73) Assignee: HCL Technologies Limited, Chennai (IN)

(21) Appl. No.: 14/503,416

(22) Filed: Oct. 1, 2014

(51) Int. Cl. G06F 9/455; G06F 9/48

(52) U.S. Cl. CPC G06F 9/45558; G06F 9/4875; G06F 2009/4557; G06F 2009/45587

(57) ABSTRACT

The invention relates to a method and system for data centre infrastructure management and, more particularly, to analyze and deploy interrelated objects in a virtual data centre at virtual deployment level. The present system monitors and identifies different elements of source virtual deployment such as configuration data, settings and so on which are scattered at different levels. Further, the system performs analysis based on various parameters such as virtual deployment performance data, past history data, future requirement and policy based data in order to identify best suitable target virtual data centre. After identifying best suited target virtual data centre, system triggers a redeployment request. Finally, system performs the redeployment of source virtual deployment to identified target virtual data centre.

The present application claims priority from Indian Application Number 4528/CHE/2013, filed on 7 Oct. 2013, the disclosure of which is hereby incorporated by reference herein.

### TECHNICAL FIELD

The embodiments herein relate to data centre infrastructure management and, more particularly, to analyze and deploy interrelated objects in a virtual data centre at virtual deployment level.

### BACKGROUND

In current scenario, ‘virtualization’ has become an essential data center technology, allowing the IT administrators to consolidate server infrastructure and reduce costs while enhancing service levels. Further, virtualization provides more efficiency and enhanced capabilities which are not possible when constrained within a physical world. Furthermore, ‘data centre virtualization’ provides other key benefits such as less heat buildup, faster redeploy, easier backups, better testing, no vendor lock in, easier migration to cloud and so on. Hence, many companies now take advantage of virtualization solutions to consolidate several specialized physical servers and workstations into fewer servers running virtual machines. The ‘virtual deployment’ in a virtual data centre can consists of different configuration data, settings and elements like multiple virtual machines, cloud management products, virtual appliances and multiple virtual applications which may contain multiple virtual machines that form a multi-tier application, network and security configurations and so on. Thus, understanding the performance of a virtual infrastructure at ‘virtual deployment level’ is a very important task which is quite challenging. Hence the system administrators or technical specialists who are responsible for maintaining, managing, protecting and configuring computer systems and their resources are often struggle to understand and monitor the virtual infrastructure, and also struggle to quickly diagnose and resolve problems.

Further, when there is any defect in infrastructure of the present virtual data centre, the redeployment of whole applications at deployment level to another suitable data centre is necessary which should be done quickly without affecting the performance of the application. Following are some reason for redeployment:
Future performance is needed which current infrastructure has limitation. For example, current Virtual Machine (VM) virtual hardware has limitation so the virtual deployment needs to be redeployed to different cloud vendor VM virtual hardware.
New deployment—Based on the analytics data, the new virtual applications or VMs should be deployed appropriately. For example, online business applications are deployed on the cloud infrastructure appropriate for it.
Due to replacement of current hardware systems into features provided by software services. For example, the current hardware like networking and security needs to be replaced by the services provided by software's.
Feature richness in different cloud infrastructure. For example, in some cases some of the new features for the current virtual deployment may be available in other cloud infrastructure.
Expected future requirement of the virtual deployment cannot meet by the present cloud environment.

Existing systems used for virtualization requires frequent user intervention at various stages of the process. This consumes more time and may affect efficiency of the system.

### SUMMARY

In view of the foregoing, an embodiment herein provides a method for redeploying interrelated objects in a virtual data centre at a virtual deployment level. Initially, elements of a source virtual deployment in a source virtual data centre are identified. Further, an analysis report is created by analyzing the identified elements. Based on the analysis report and identified elements, a policy data and a history data are updated. Further, a redeployment requirement is identified and a redeployment request is constructed. Further, a suitable target cloud is identified and the source virtual deployment to the identified target cloud.

Embodiments further disclose a system for redeploying interrelated objects in a virtual data centre at a virtual deployment level. The system configured for identifying elements of a source virtual deployment in a source virtual data centre using a virtual deployment analyzer. Further, an analysis report is created by analyzing the identified elements using the virtual deployment analyzer. Further the system updates a policy data and a history data based on the analysis report and identified elements and identifies a redeployment requirement using the virtual deployment analyzer. After identifying the redeployment request, the system constructs a redeployment request and identifies a target cloud using the virtual deployment analyzer. Further, the system redeploys the source virtual deployment to the identified target cloud using the virtual deployment analyzer.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of Intelligent analytics based virtual deployment system, as disclosed in the embodiments herein;

FIG. 2 illustrates a block diagram that shows various components of virtual deployment analyzer, as disclosed in the embodiments herein;

FIG. 3 illustrates a block diagram that shows various components of cloud monitoring module, as disclosed in the embodiments herein;

FIG. 4 illustrates a block diagram that shows various components of memory module, as disclosed in the embodiments herein;

FIG. 5 illustrates a block diagram that shows various components of analyzer engine, as disclosed in the embodiments herein;

FIG. 6 illustrates a block diagram that shows various components of deployment initiator module, as disclosed in the embodiments herein; and

FIG. 7 is a flow diagram which shows various steps involved in the process of analyzing and deploying source virtual deployment to target virtual data centre, as disclosed in the embodiments herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the below description terms “target cloud” and “target virtual data centre” are used interchangeably.

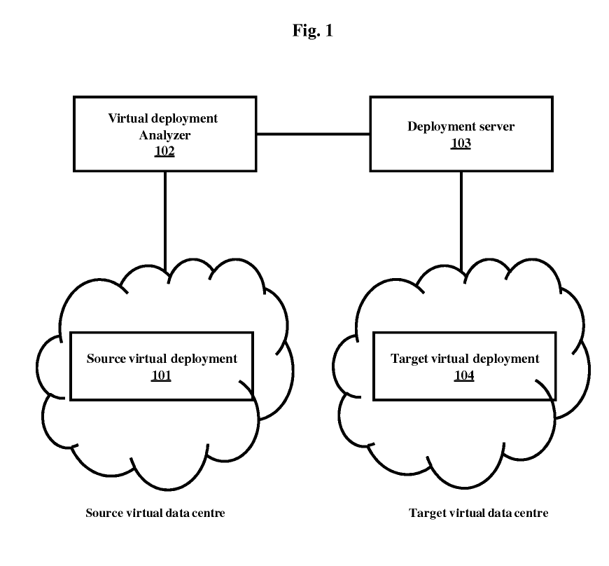

The embodiments herein disclose a system and method for intelligent redeployment of source virtual deployment by monitoring and analyzing interrelated objects in a virtual data centre at virtual deployment level. Referring now to the drawings, and more particularly to FIGS. 1 through 7, where similar reference characters denote corresponding features consistently throughout the figures, there are shown embodiments.

FIG. 1 illustrates a block diagram of intelligent analytics based virtual deployment system, as disclosed in the embodiments herein. The system comprises of a source virtual deployment 101, a virtual deployment analyzer 102, a deployment server 103 and a target virtual deployment 104. The term ‘source virtual deployment’ may be any ‘virtual deployment’ which is hosted on a virtual data centre. Further, the ‘virtual deployment’ in a virtual data centre can consists of different configuration data, settings and elements such as multiple virtual machines, cloud management products, virtual appliances and multiple virtual applications which may contain multiple virtual machines that form a multi-tier application, network and security configurations and so on. Further, the configurations, settings and elements of such virtual deployment may be scattered across different layers. Consider the following examples:
Virtual switch properties will be in hypervisor level
Resource properties of virtual machines will be in virtual machine layer
Application properties will be in application level
Properties like container, catalog, templates, network and security will be in management layer.

List below shows some of the configurations/properties which will be analyzed for the virtual deployment.

| Component | Parameter |
|---|---|
| Hypervisor | Hypervisor Firewall Setting |
| | Example Ports opened, security patches installed, security profiles for the hypervisor. |
| | CPU parameters - CPU load of the hypervisors, CPU scheduling parameters |
| | Memory Parameters - Memory load of the hypervisor platform, swap in swap out reports |
| | Networking - IO throughput of the vSwitch, management port, Security settings of the |
| | vSwitch port, management port, traffic shaping parameters of the vSwitch network ports, |
| | Hardware details - Details of the Hardware - Servers, Storage, controllers, switches etc |
| VM | Type of Network Adapter and performance parameters - Example e1000, high throughput |
| | network adapter of the vendor like VMware vmxnet3. |
| | Load balancing feature support |
| | Memory - memory parameters, max memory permissible to guest VM |
| | vCPU - vCPU settings, max vCPU supported |
| | SCSI Adapter - Virtual scsi adapter properties, through put for the adapter, max adapter |
| | supported, max through put of the adapter |
| | VM load balancing features support - The various load balancing features supported |
| Application | Network - Network ports to be enabled for the App, Network throughput required |
| | catalogue- The catalogue for the Appliance |
| | Security - Security profile for the application |
| | Load Balancing policies of the Application |
| | Enterprise Application performance for various applications |
| Management Layer | NAT properties |
| | Internal network, external network, isolated network properties |
| | VPN settings for accessing the external secured services. |
| Infrastructure | Storage - Volume performance, Storage features, Scalability features and properties |
| | Network - Security properties, Network performance and bandwidth properties and stats, |
| | Network high availability properties |
| | Switch - Network features, port and switch performance parameters, switch energy |
| | parameters, switch scalability features properties |

For example, the isolated virtual environment created by a customer in a multi-tenant cloud platform can be considered as a ‘virtual deployment’. Typically, such virtual deployment environment may contain:
Virtual machines like an authentication server, security servers (like firewall)
Virtual appliances (each of these appliances may have multiple virtual machines) for providing services to the end user
Setting/configurations as mentioned in TABLE-1 such as security, network and other settings such as Isolated virtual networks not accessible from internal virtual machines, virtual external network for end user to access with selective access, Network Address Translation (NAT) routed virtual network for load balancing, Virtual Private Network (VPN) settings for accessing the external secured services and so on.

Further, the virtual deployment analyzer 102 present in the Intelligent analytics based virtual deployment system identifies and analyzes source virtual deployment 101 hosted on the virtual data center based on various parameters as mentioned in TABLE-1, virtual deployment performance data, past history data, future requirement and policy based data. In an embodiment, future requirement data and policy data are pre-configured to the database present in the memory module 202. Based on the analysis result, the virtual deployment analyzer 102 suggests the redeployment of source virtual deployment 101 to best suitable target virtual deployment 104 through deployment server 103 present in the system.

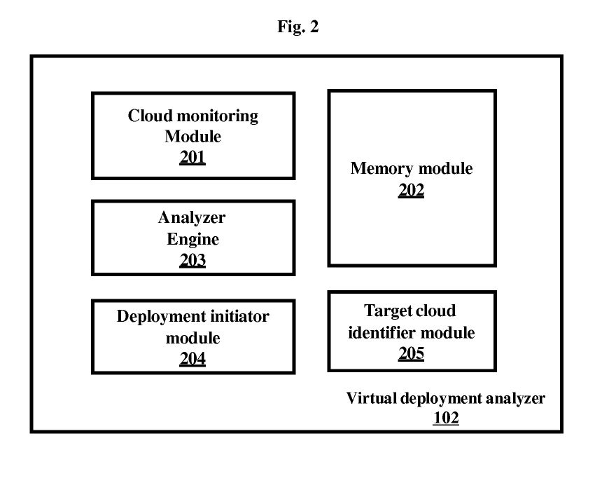

FIG. 2 illustrates a block diagram that shows various components of virtual deployment analyzer, as disclosed in the embodiments herein. The virtual deployment analyzer comprises of a cloud monitoring module 201, a memory module 202, an analyzer engine 203, a deployment initiator module 204 and a target cloud identifier module 205. The cloud monitoring module 201 monitors the virtual applications, virtual machines and management plane environment properties of source virtual deployments 101 as mentioned in TABLE-1 present in the virtual data centre. The memory module 202 of virtual deployment analyzer 102 maintains a database in which the monitored data is collected. The database present in the memory module 202 further comprises of pre-configured parameters such as virtual deployment performance data, past history data, future requirement and policy based data. Further, the analyzer engine 203 analyzes the monitored data and takes decision on virtual deployment re-deployment. If re-deployment is desired, deployment initiator 204 initiates deployment process by constructing redeployment request. Further, the deployment initiator 204 passes the redeployment request to target cloud identifier module 205 which identifies the best suitable target virtual deployment 104 available at target virtual data centre.

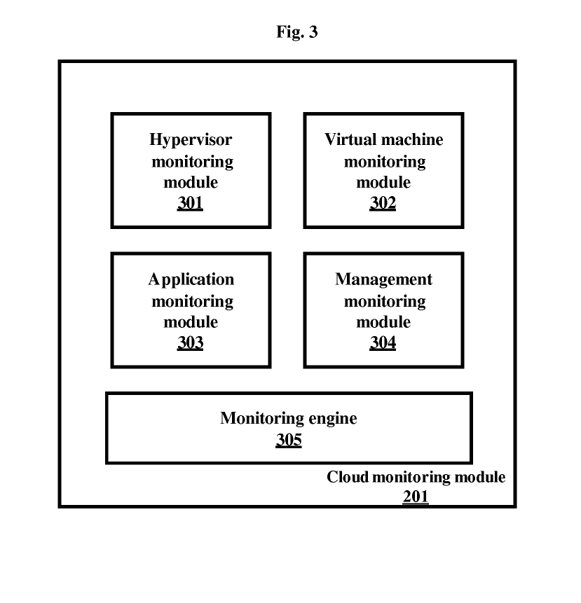

FIG. 3 illustrates a block diagram that shows various components of cloud monitoring module, as disclosed in the embodiments herein. The cloud monitoring module 201 further comprises of a hypervisor monitoring module 301, a virtual machine monitoring module 302, an application monitoring module 303 and a management monitoring module 304 and a monitoring engine 305. The cloud monitoring module 201 monitors different virtual deployment elements present in the source virtual deployment 101. Further, the source virtual deployment elements, properties and settings as mentioned in TABLE 1 are scattered in the various levels of source virtual cloud environment such as at hypervisor level, virtual machine level, virtual application level and cloud management level.

The hypervisor monitoring module 301 of cloud monitoring module 201 monitors the hypervisor level performances and its configurations such as CPU parameter, Memory parameters, Network bandwidth parameters and so on, present in the source virtual deployment 101. Similarly, the virtual machine monitors module 302 monitors the virtual machine level performance and its properties such as but not limited to VM SCSI data, VM network dataVM memory performance, and VM vCPU stats. The application monitoring module 303 present in the cloud monitoring module 201 monitors the virtual application level monitoring and their configurations. Further, the management monitoring module 304 monitors the cloud management level configuration and its properties. Finally, the monitoring engine 305 consolidates the monitored data and manages it with respect to source virtual deployment 101.

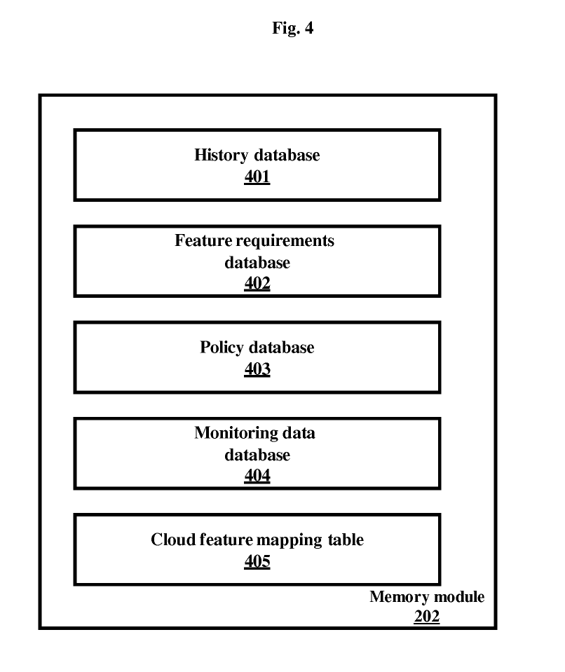

FIG. 4 illustrates a block diagram that shows various components of memory module, as disclosed in the embodiments herein. The memory module 202 further comprises of a history database 401, a future requirements database 402, a policy database 403, a monitoring data database 404 and a cloud feature mapping table 405. The history database 401 contains the past history of the source virtual deployment 101 performance in the cloud, which helps the analyze engine 203 for future trends and course of actions. In an embodiment, the data regarding past history of the source virtual deployment is collected based on the actions that are taken previously by the source virtual deployment 101. The future requirements database 402, may contain the anticipated future requirements from virtual deployments such as but not limited to:
Expected storage, compute scale up requirement for the existing VM or virtual applications in the virtual deployment
Increase and decrease in number of VMs and virtual applications in the virtual deployment
Compatibility requirements like the future enhancements may expect specific hypervisor versions or type for functioning.

Further, the policy database 403 have may have parameters and threshold values for the target virtual deployment 104 needs to meet. The parameters may also include but not limited to Input Output performance, threshold or feature needs and so on. The monitoring data database 404 maintains the data which is collected by cloud monitoring module 201. In an embodiment, the future requirements and policy data can be pre-configured with the database as per the user's requirements. The cloud feature mapping table 405 further comprises information on a list of clouds available in the network and corresponding features. The information related to various clouds and corresponding features may be used at a later stage so as to identify a suitable target cloud so as to redeploy a source virtual deployment.

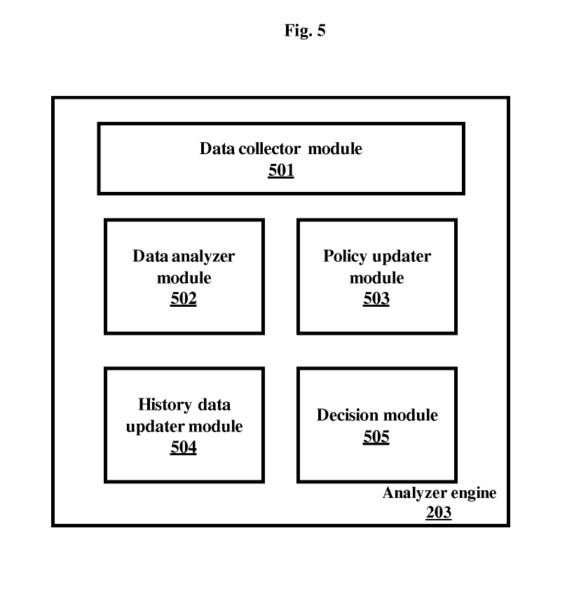

FIG. 5 illustrates a block diagram that shows various components of analyzer engine, as disclosed in the embodiments herein. The analyzer engine 203 further comprises of a data collector module 501, a data analyzer module 502, a policy updater module 503, a history data updater module 504 and a decision module 505. The data collector module 501 of analyzer engine 203 collects the monitored data from monitoring database 404 present in memory module 202. After retrieving data from the memory module 202, the data analyzer module 502 performs the analysis of retrieved data. For this purpose, the data analyzer module 502 uses pre-configured data present in history database 401, future requirements database 402 and policy database 403 of memory module 202 and creates a ‘virtual deployment analysis report’. Further, based on the analysis report and monitored data, the policy data and history data is updated through policy updater module 503 and history data updater module 504. This step i.e., updating policy data and history data can further enhances the future analytics while redeploying other source virtual deployments. Furthermore, the decision module 505 takes decision on ‘source virtual deployment 101 redeployment’ based on the analysis performed by the data analyzer module 502. If re-deployment is desired, decision module 505 further invokes the deployment initiator module 204 of virtual deployment analyzer 102. For example, say the VM performance presently for the SCSI module is x IOPS per second and the required is x+y IOPS per second. The different SCSI adapter can provide the new IOPS then decision will be made to redeploy the application with new SCSI controller.

Another use case scenario is in a multi tenanted cloud deployment environment, each tenant is expected to have an isolated virtual deployment. For example consider the case of delivering a complete test management system as a service. In this case each virtual deployment may have:
A test management web application which could be a 2-tier application with web server and database. The web server needs to have access from external network and DB should have accessibility only to the web application. Also the DB is having a specific storage and back up requirement like need to backed on every minutes and should be available even on the crash of the virtual machines
Bug tracking system, also can be multi-tier web application with specific accessibility and security requirements as that of Test management application.
Independent virtual machines to provide uniform identity management

The web applications of the same tenant should have accessibility to each other's but should be isolated from the other tenants. The web application virtual machines may need to scale up or down based on the user traffic and should be accessed through a load balancer. The DB volumes may need to scale based on the incoming and outgoing data size.

In this case the various levels of monitoring will help to track the performance of the virtual deployment on hypervisor level, VM level, application level and management level and take redeployment decision if required. For example continues spike in incoming traffic can trigger a scaling up of the applications based on the configured scalability policy but cannot handle in the current cloud due the infrastructure limitation. In this scenario based on the past history, configured SLA, it can conclude on any of the re-deployment decision as: (1) scale up the web application alone to a cloud which has infrastructure available and establish the connectivity (2) re-deploy whole virtual deployment of the tenant to an appropriate target cloud and scale up (3) re-deploy another less priority virtual deployment to a target cloud and make room for the scale up.

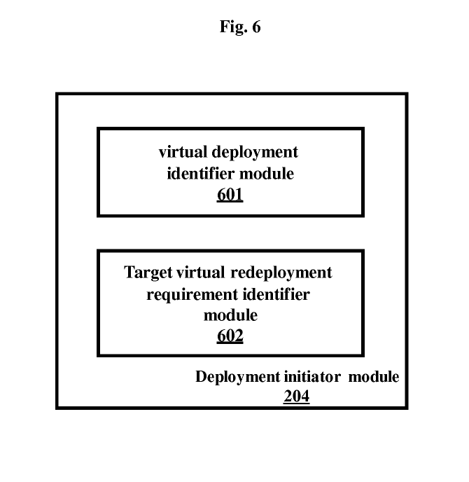

FIG. 6 illustrates a block diagram that shows various components of deployment initiator module, as disclosed in the embodiments herein. The deployment initiator module 204 further comprises of a virtual deployment identifier module 601 and a target virtual redeployment requirement identifier module 602. The virtual deployment identifier module 601 which is invoked by analyzer engine 203 constructs a ‘redeployment request’ for redeploying source virtual deployment 101. Further, the ‘redeployment request’ contains virtual deployment details of the source virtual data centre (constructed by using virtual deployment identifier module 601), the expected performance requirement and future expansion requirement (constructed by using target virtual redeployment requirement identifier module 602).

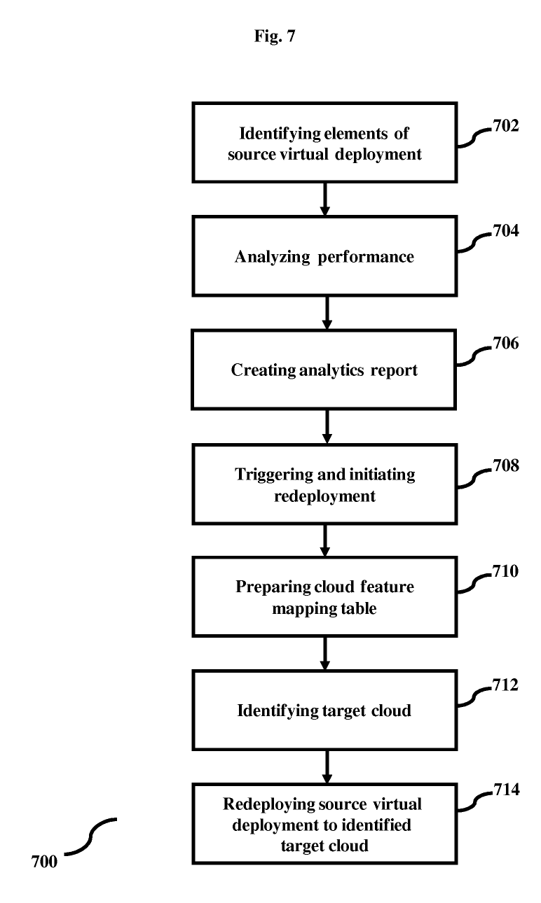

FIG. 7 is a flow diagram which shows various steps involved in the process of analyzing and deploying source virtual deployment to target virtual data centre, as disclosed in the embodiments herein. Initially, the intelligent analytics based virtual deployment system is pre-configured with data regarding future requirements and policy parameters that are to be followed while selecting a virtual data center. Further, the virtual deployment analyzer 102 present in the intelligent analytics based virtual deployment system considers the whole source virtual deployment 101 which is running on current source virtual data centre as a single entity. Now, the monitoring engine 305 of cloud monitoring module 201 identifies (702) different elements of source virtual deployment 101 such as configuration data, settings as mentioned in TABLE-1 and so on which are scattered at different levels. In an embodiment, the monitoring engine 305 of cloud monitoring module 201 proactively identifies (702) different elements present in source virtual deployment 101. The identification and monitoring of these scattered elements can be done by using hypervisor monitoring module 301, virtual machine monitoring module 302, application monitoring module 303 and management monitoring module 304 present in the cloud monitoring module 201. Further, the monitored data is consolidated on virtual deployment level and stored in the monitoring data database 404 present in the memory module 202.

Later, the data collector module 501 of analyzer engine 203 collects the monitored data for further processing. Further, the data analyzer module 502 of analyzer engine 203 performs the analysis (704) of retrieved monitored data. This analysis can be done based on the pre-configured parameters at various levels like virtual deployment performance data, past history data, future requirements data and policy data present at history database 401, future requirements database 402 and policy database 403 respectively of the memory module 202. Values of the parameters stored in the memory module 202 may be dynamically changed.

After analyzing the monitored data with the pre-configured parameters, data analyzer module 502 creates (706) an analysis report. Based on the analysis report and monitored data, the policy data and history data is updated through policy updater module 503 and history data updater module 504 which enhances the future analytics. Further, the decision module 505 takes decision on source virtual deployment 101 redeployment by considering analysis report, future requirements data, configured policy and history data which are present in the memory module 202. In case of redeploying new applications, as the past history data is not available, the decision is taken by considering policy data, future requirements and monitored data. If redeployment is necessary, the decision module 505 invokes the deployment initiator module 204 for initiating (708) the deployment process. Further, the deployment initiator module 204 constructs a ‘redeployment request’ for virtual deployment by using virtual deployment identifier module 601 and target virtual redeployment requirement identifier module 602. In an embodiment, the redeployment request comprises of source virtual deployment details, expected performance requirement and future expansion requirements.

Further, the constructed redeployment request is passed to target cloud identifier module 205. The target cloud identifier module 205 based on the received redeployment request, identifies the best suitable target virtual deployment cloud 104 by using the cloud feature mapping table 405 present in the memory module 202. In an embodiment, a cloud feature mapping table 405 is prepared (710) and pre-configured in memory module 202 which maintains a list of target cloud vendor properties that are compared to the future requirements and policies of the applications which are to be redeployed. Further, a suitable target virtual deployment cloud is identified (712) from list of available cloud vendors by comparing the required parameters with the existing cloud vendor parameters. Now, the redeployment request is passed to deployment server 103 which is present in intelligent analytics based virtual deployment system. The deployment server 103 further locates the identified source virtual deployment 104 and converts the identified source virtual deployment 104 into a cloud independent standard entity. Further, a target virtual deployment which is specific to the target cloud is prepared by the deployment server 103. Finally, the converted target cloud specific virtual deployment is deployed (714) to identified target cloud 104 and verifies its performance and features.

In an embodiment, the clouds in which the source and target data centers reside can be same or they can be of different clouds. For example, if there is problem with the ‘networking gates’ present in the source virtual data centre, then there is no need of changing the source cloud as the problem is resolved by changing the virtual network present in the source virtual data centre. Thus, depending on the type of problem encountered in the source virtual deployment 101, redeployment can be done.

The various actions in method 700 may be performed in the order presented, in a different order or simultaneously. Further, in some embodiments, some actions listed in FIG. 7 may be omitted.

The embodiments disclosed herein can be implemented through at least one software program running on at least one hardware device and performing network management functions to control the network elements. The network elements shown in FIG. 1 to FIG. 6 include blocks which can be at least one of a hardware device, or a combination of hardware device and software module.

The embodiment disclosed herein specifies a system for data centre infrastructure management. The mechanism allows analyzing and deploying interrelated objects in a virtual data centre to a target virtual data center at virtual deployment level by providing a system thereof.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for redeploying interrelated objects in a virtual data centre at a virtual deployment level, said method comprises:
identifying elements of a source virtual deployment in a source virtual data centre;
creating an analysis report by analyzing said identified elements;
updating a policy data and a history data based on said analysis report and identified elements;
identifying a redeployment requirement;
constructing a redeployment request upon identifying said redeployment requirement;
identifying a target cloud; and
redeploying said source virtual deployment to said identified target cloud.

2. The method as in claim 1, wherein said element further comprises of at least one of a plurality of configuration data and settings of said source cloud.

3. The method as in claim 1, wherein said elements of the source virtual deployment are identified proactively.

4. The method as in claim 1, wherein said redeployment requirement is identified based on said analysis report, future requirement, policy data and history data.

5. The method as in claim 1, wherein said redeployment request comprises of a plurality of source virtual deployment details, expected performance requirement and future expansion requirements.

6. The method as in claim 1, wherein identifying said target cloud further comprises:
preparing a cloud feature mapping table; and
comparing said redeployment request with said cloud feature mapping table.

7. The method as in claim 6, wherein said cloud feature mapping table comprises information on a plurality of clouds and corresponding features.

8. A system for redeploying interrelated objects in a virtual data centre at a virtual deployment level, said system configured for:
identifying elements of a source virtual deployment in a source virtual data centre using a virtual deployment analyzer;
creating an analysis report by analyzing said identified elements using said virtual deployment analyzer;
updating a policy data and a history data based on said analysis report and identified elements using said virtual deployment analyzer;
identifying a redeployment requirement using said virtual deployment analyzer;
constructing a redeployment request upon identifying said redeployment requirement using said virtual deployment analyzer;
identifying a target cloud using said virtual deployment analyzer; and
redeploying said source virtual deployment to said identified target cloud using said virtual deployment analyzer.

9. The system as in claim 8, wherein said virtual deployment analyzer is further configured to identify at least one of a plurality of configuration data and settings as elements of said source cloud using a cloud monitoring module.

10. The system as in claim 9, wherein said cloud monitoring module is further configured to proactively identify elements of said source cloud.

11. The system as in claim 8, wherein said virtual deployment analyzer is further configured to identify said redeployment requirement based on said analysis report, future requirements, policy and history, using an analyzer engine.

12. The system as in claim 8, wherein said virtual deployment analyzer is further configured to identify said target cloud by:
preparing a cloud feature mapping table; and
comparing redeployment request with said cloud feature mapping table.
